(19) United States
(12) Patent Application Publication
(10) Pub. No.: US 2015/0336596 A1
(43) Pub. Date: Nov. 26, 2015

(54) Golf Buggy Steering System

(71) Applicant: James Imre Kovacs, Shoalhaven Heads (AU)

(72) Inventor: James Imre Kovacs, Shoalhaven Heads (AU)

(21) Appl. No.: 14/696,475

(22) Filed: Apr. 26, 2015

(30) Foreign Application Priority Data
May 26, 2014 (AU) 2014901978
Jan. 26, 2015 (AU) 2015900262

(51) Int. Cl. B62B 3/00; B62B 3/12

(52) U.S. Cl. CPC B62B 3/001; B62B 3/12; B62B 2202/404

(57) ABSTRACT

A steering system for a three-wheeled buggy; the buggy including a pair of spaced apart rear wheels and a front wheel attached to a frame; the buggy further including a handle pivotally mounted to the frame; the handle operatively interconnected with an articulated frame member supporting the front wheel.

### TECHNICAL FIELD

The present invention relates to buggies for carrying golf bags and associated equipment and, more particularly to three-wheeled golf buggies.

### BACKGROUND

Golf bags for serious golfers are large affairs accommodating a large number of clubs and therefore quite heavy. Thus most golfers who still prefer to walk around a golf course, choose to use a hand pulled, pushed or battery/electric driven golf buggy to carry the golf bag and clubs.

Three-wheeled buggies are popular because, unlike two-wheeled buggies, the load is always stably supported by the three wheels.

A disadvantage of the typical three-wheeled arrangement in which the front wheel is fixed in orientation, (that is parallel to the two rear wheels), is that to steer the buggy, it must be tilted to clear the front wheel off the ground so as to allow the buggy to be swung into a new direction. Thus a tendency in the design of these buggies is to bias the load centre towards the rear wheels which is counter to a more desirable evenly distributed load.

Some buggies have a relatively long wheel base, that is, a relatively long distance between the front wheel contact point and the line of contact points of the rear wheels, so that with a heavy golf bag load, the frequent tilting of the buggy for steering becomes inconvenient.

Electrically driven buggies have a further disadvantage in steering due to the rear drive wheels rotating in locked unison driving the buggy in a straight line. Not only must the front wheel be lifted clear off the ground, effort is required to overcome the drag of the outer rear wheel as the change in direction is made.

Another disadvantage of buggies with a fixed front wheel is that when travelling across sloping terrain, gravity tends to pull the buggy down the slope and away from the desired line of travel.

It is an object of the present invention to address or at least ameliorate some of the above disadvantages or provide a useful alternative.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly in one broad form of the invention there is provided a Steering system for a non passenger carrying golf buggy or cart that has the capability of carrying golf equipment.

Preferably, when the handle of the golf buggy is rotated, a cable system attached from this handle arrangement to the front wheel's axle arrangement forces the axle and attached wheel to change direction thus enabling controlled steering by the user.

Preferably, the axle and wheel is fitted in a slot along the inside of the axle frame. The axle is free to move in both directions along the frame. The axle is held in a neutrally square position by a combination of springs at both its ends, and by tension of the controlling inner cables attached to both ends of the said axle. This enables the buggy to travel straight when no steering is used. When either of the inner cables is pulled at one end of the axle, and tension released from the opposite inner cable, the axle will move off its neutral position allowing the attached wheel to change direction.

In a further broad form of the invention, there is provided a steering system for a three-wheeled buggy; the buggy including a pair of spaced apart rear wheels and a front wheel attached to a frame; the buggy further including a handle pivotally mounted to the frame; the handle operatively interconnected with an articulated frame member supporting the front wheel.

Preferably, the articulated frame member is a fork; the fork pivoting about a generally vertical axis relative a main portion of the frame.

Preferably, rotation of the handle relative the frame results in rotation of the fork about the generally vertical axis.

Preferably, rotation of the handle is communicate to the fork and the front wheel through at least one flexible cable.

Preferably, rotation of the handle is communicated to the fork through a pair of flexible cables; a tensioning of the first flexible cable of the pair of flexible cables causing a rotation of the fork to the right relative the main portion of the frame; a tensioning of the second flexible cable of the pair of flexible cables causing a rotation of the fork to the left when the handle is rotated respectively in a clockwise and an anti-clockwise direction about a pivot axis of the handle.

Preferably, the at least one or the pair of flexible cables are Bowden cables; the cables comprising a flexible outer sheath and a flexible inner cable.

Preferably, a first end of the inner cable of the at least one, or the pair of flexible cables, is attached to a body rigidly mounted to a pivot shaft of the handle; a first end of a corresponding flexible outer sheath affixed to the main portion of the frame proximate the body.

Preferably, a second end of the inner cable of the at least one, or the pair of flexible cables, is attached to the fork; a second end of a corresponding outer sheath affixed to the main portion of the frame proximate the generally vertical axis.

Preferably, a connection point of the first end of the inner cable on the body lies at a radial distance from the pivot axis such that a maximum angle of rotation of the body with rotation of the handle causes a tensioning of the inner cable sufficient to urge a maximum rotation of the front wheel.

Preferably, the body comprises at least a portion of a cylinder; the first end of at least one or each inner cable attached at a periphery of the grooved cylinder; a portion of the inner cable passing around a portion of the periphery.

Preferably, the at least one flexible cable is a single Morse type Bowden cable; rigid rod elements at leading and trailing ends of the single Morse type Bowden cable linked respectively to the fork of the front wheel and to the steering handle; the rigid rod elements interconnected by a flexible cable extending through an outer sheath of the Morse type Bowden cable.

Preferably, a spring acts between the front wheel and the frame to bias the front wheel into a default centered position.

In another broad form of the invention, there is provided a method of steering a three-wheeled golf buggy; the method including the steps of:
rotating a handle portion of a frame of the buggy relative the frame,
transmitting rotation of the handle portion to an articulated front wheel of the buggy via at least one or a pair of cables.

Preferably, the at least one or pair of cables are flexible Bowden cables.

Preferably, the at least one or a pair of cables comprises a single Morse type Bowden cable.

Preferably, rotation of the handle is transmitted to the articulated front wheel by a pair of flexible Bowden cables.

Preferably, rotation of the handle portion rotates a grooved cylindrical body; first ends of inner cables of the pair of flexible Bowden cables attached to, and at least partly wound around, respective grooves of the grooved cylindrical body.

Preferably, second ends of the inner cables of the pair of flexible Bowden cables are attached to respective sides of a front fork of the articulated front wheel.

Preferably, rotation of the front wheel about an axis of rotation is driven by extension and retraction of a leading end rigid rod extending from a leading end of the single Morse type Bowden cable and connected to the front fork of the golf buggy; extension and retraction of the leading end rigid rod being induced by rotation of the steering handle connected to a trailing end rigid rod extending from a trailing end of the single Morse type Bowden cable.

### BRIEF DESCRIPTION OF DRAWINGS

Embodiments of the present invention will now be described with reference to the accompanying drawings wherein:

FIG. 1 is a schematic view of a first preferred embodiment of a steering system according to the invention,

FIG. 2 is a perspective view of the principle elements of the steering system of FIG. 1,

FIG. 3 is a further partial view of the steering system of FIG. 1 showing relative angular movement between a frame element and a fork,

FIG. 4 is a side view of a three-wheeled golf buggy incorporating the steering arrangement according to the invention,

FIG. 4A is an enlarged view of the front wheel steering arrangement of FIG. 4,

FIGS. 5 and 6 are plan views of the buggy of FIGS. 4 and 4B showing the steerable front wheel in a straight ahead and in a turn to the right position respectively,

FIG. 7 is an enlarged plan view of the upper end of the frame, handle and cable control body of the buggy with the handle rotated clockwise for a right hand turn,

FIG. 7A is a further enlargement of a portion of the control body and cable arrangement of FIG. 7,

FIG. 8 is an enlarged plan view of the front wheel in response to the rotation of the handle as shown in FIGS. 7 and 7A,

FIGS. 9 and 10 illustrate a further embodiment of the invention in which the steering is controlled via a single Morse type Bowden cable.

### DESCRIPTION OF EMBODIMENTS

### First Preferred Embodiment

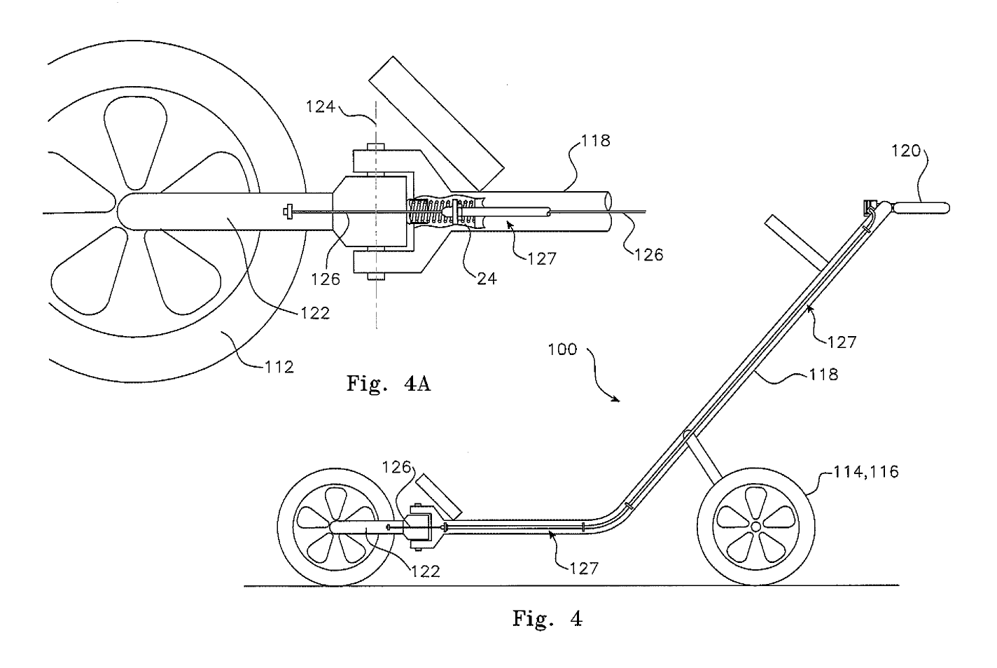

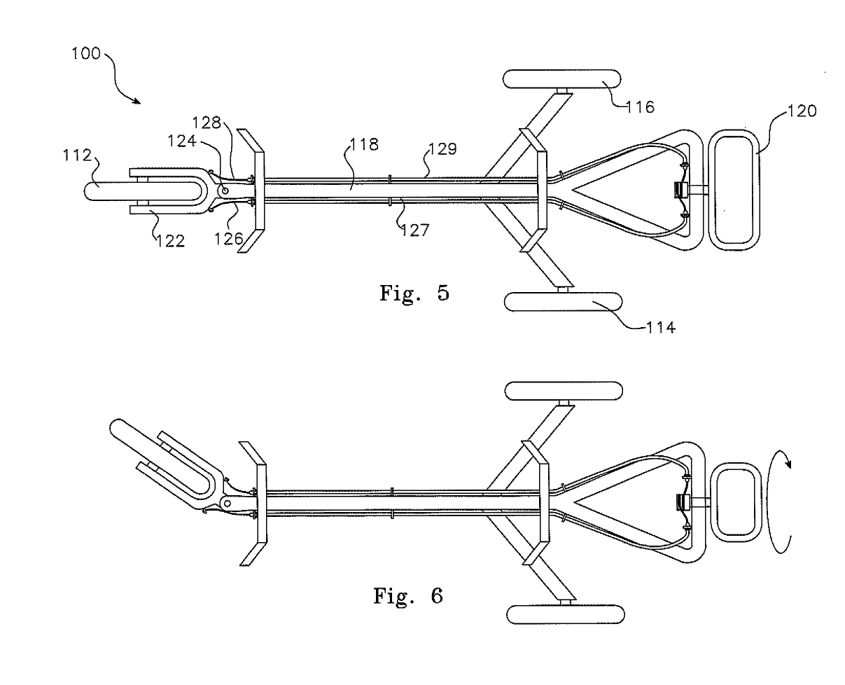

The golf buggy to which the present invention is applied, is a three-wheeled buggy for carrying a golf bag. The buggy includes a pair of spaced apart rear wheels and a front wheel attached to a frame as shown in FIGS. 4 to 6. For the steering system 10 of the invention, the buggy further includes a handle pivotally mounted to the frame, which is operatively interconnected with an articulated frame member supporting the front wheel. The buggy may be provided with a battery/electric motor system (not shown) for driving the rear wheels.

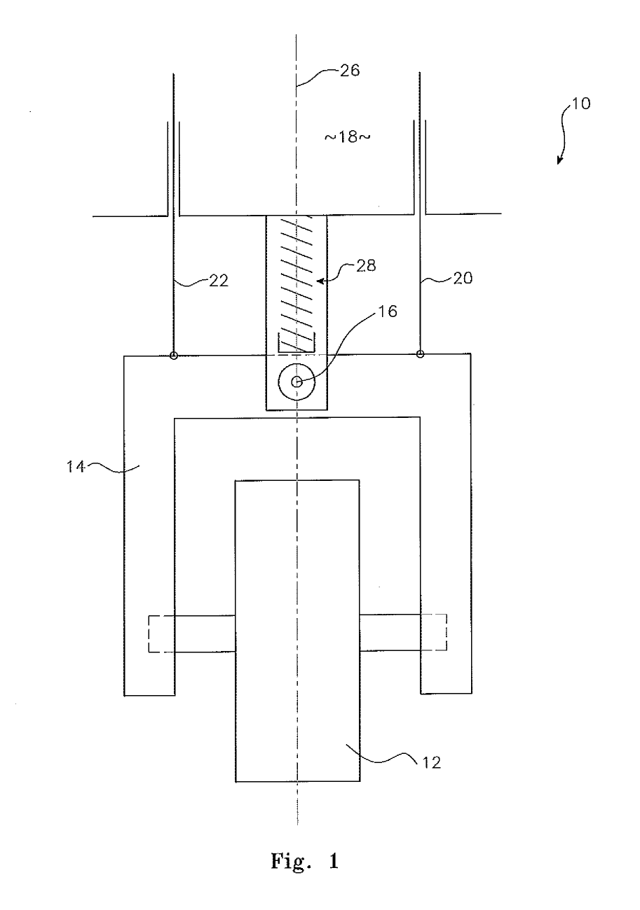

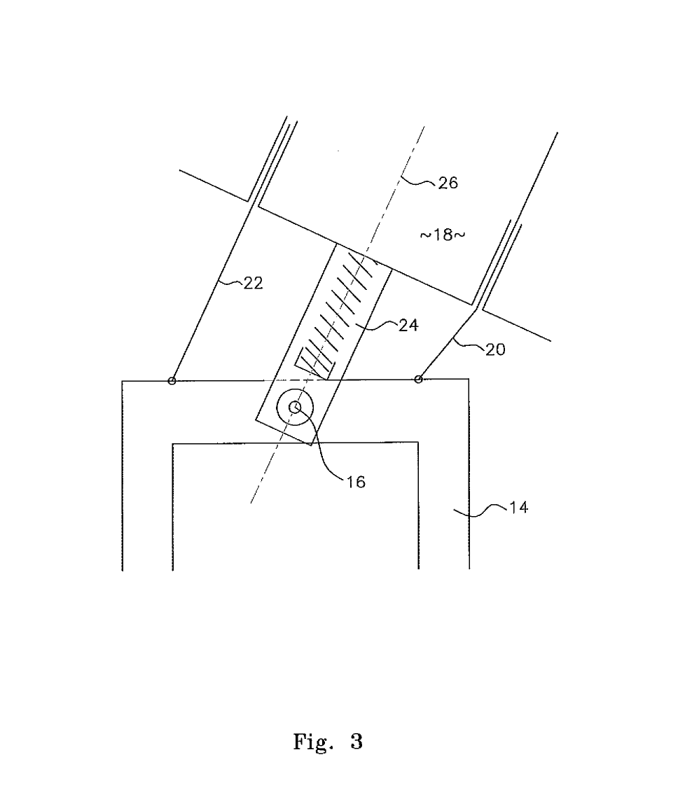

With reference firstly to FIGS. 1 and 3, the articulated frame member supporting the front wheel 12 is preferably a fork 14 pivoting about a generally vertical axis 16 relative a main portion 18 of the frame of the buggy.

The fork 14 is acted upon by at least one, but preferably, as shown in FIGS. 1 to 3, two cables 20 and 22 attached to the fork 14 proximate to, and to either side of the vertical axis 16. When tension is applied to one of the cables 20 or 22, while the other cable is relaxed, the fork 14 rotates about the vertical axis 16 as shown in FIG. 3.

A spring 24 acts against the fork 14 to bias the fork into a default centered position as shown in FIG. 1, in which the front wheel 12 is aligned parallel with the longitudinal axis 26 of the buggy for straight ahead movement of the buggy.

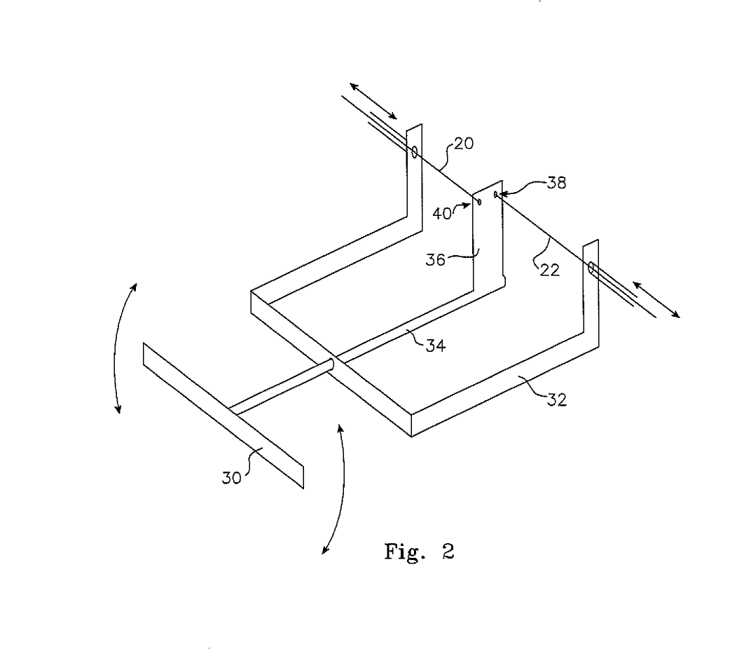

In this first preferred embodiment with reference now to FIG. 2, a handle 30 is pivotally mounted relative portions 32 of the main frame of the buggy. A shaft 34 connects the handle 30 to a plate 36 which is rigidly attached to the shaft 34. The first ends 38 and 40 of the cables 20 and 22 are attached to either side of the plate 36.

It can be seen that, as the handle 30 rotates, for example in a clockwise direction, that tension will be applied to cable 20 while cable 22 will be relaxed. By this means the rotation of the handle 30 is transmitted to the fork 14 and front wheel 12 to urge the fork and wheel into an angled position and thus steer the buggy out of the straight ahead direction.

### Second Preferred Embodiment

With reference now to FIGS. 4 to 8, a three-wheeled buggy 100 includes, as above, a front wheel 112 and spaced apart rear wheels 114 and 116 attached to a frame 118. The buggy 100 further includes a handle 120 pivotally mounted to the frame 118.

The handle 120 is operatively interconnected with an articulated frame member, preferably in the form of a fork 122 supporting the front wheel 112. The fork 122 pivots about a generally vertical axis 124 relative a main portion of the frame 118.

The handle 120 and the fork 122 are interconnected by at least one, but as above, preferably two flexible cables 126 and 128. Preferably cables 126 and 128 are the inner cables of Bowden cables 127,129 which comprise of a flexible outer sheath in which the flexible inner cable is free to travel.

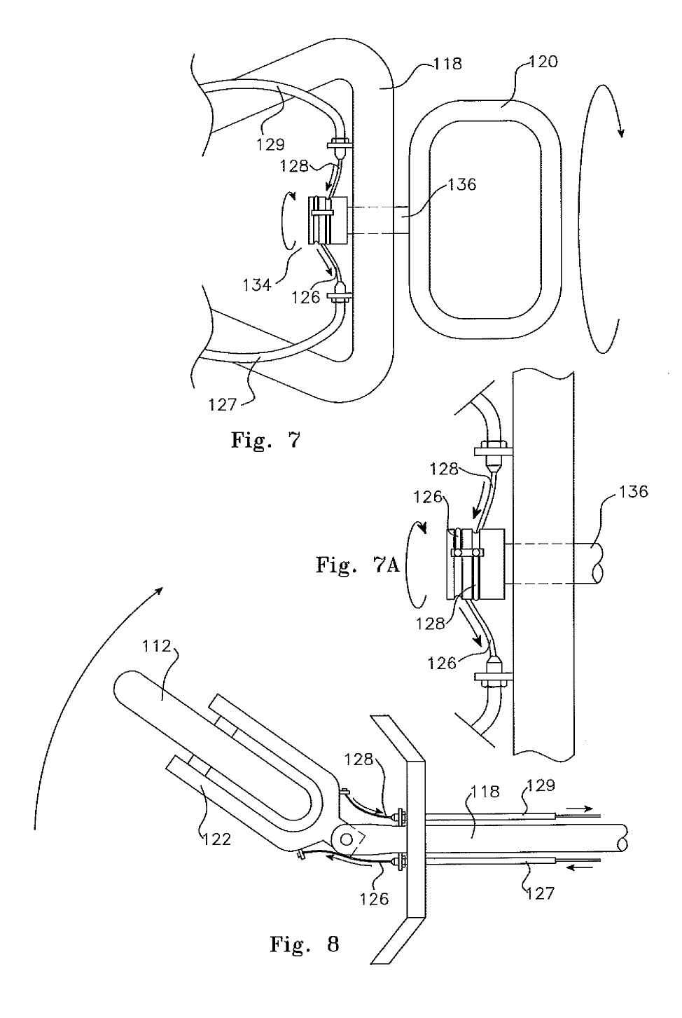

As can be seen from the enlargements of FIGS. 7 and 8, the outer ends of the outer sheaths of the Bowden cables 127 and 129 are fixed to the frame 118 proximate the fork 122 and proximate the handle 120, leaving exposed sufficient lengths of the inner cables 126,128 to allow for the movements of the cables induced by rotation of the handle 120 and the fork 122.

With particular reference to FIGS. 7 and 7A, the first ends of the inner cables 126 and 128 of the pair of Bowden cables, are attached to a body 134 rigidly mounted to a pivot shaft 136 of the handle 120. Preferably, the body 134 is a cylinder provided with two annular grooves, with the ends of the two inner cables 126,128 wound at least part way around these grooves and fixed to the body 134.

It can be seen from FIGS. 7 and 7A that when the handle 120 is rotated, the rotation of the grooved body 134 will apply tension to one of the inner cables while relaxing tension in the other. Thus as illustrated in FIG. 7A, with a clockwise rotation of the handle 120, inner cable 128 is wound further onto the body 134 while cable 126 is partly unwound.

The diameter of body 134 is selected such that a reasonable maximum rotation angle of the handle 120, that is, reasonable in respect of the ease of handling by the hand/s and wrist/s of a user, the movement of the tensioned inner cable 128 urges a maximum steering angle of the fork 122.

Rotation of the handle 120 is communicated to the fork 122 through the pair of flexible inner cables; a tensioning of the first flexible cable 128 of the pair of flexible cables causing a rotation of the fork to the right relative the main portion of the frame 118, while a tensioning of the second flexible cable 126 causes a rotation of the fork to the left when the handle is rotated respectively in a clockwise or an anti-clockwise direction.

As shown in the enlargement of FIG. 8, the second, or other ends of the inner cables 126,128 are attached to either side of the fork 122, with the second or other ends of the flexible outer sheaths of the Bowden cables 127,129 fixed to the main frame 118. FIG. 8 shows the movements of the two inner cables 126,128 in response to the corresponding movements induced by the rotation of the body 134.

A bias towards a centering of the front wheel 112 to the straight ahead direction can be induced by a spring acting on the fork 122 as described for the first embodiment above.

### Third Preferred Embodiment

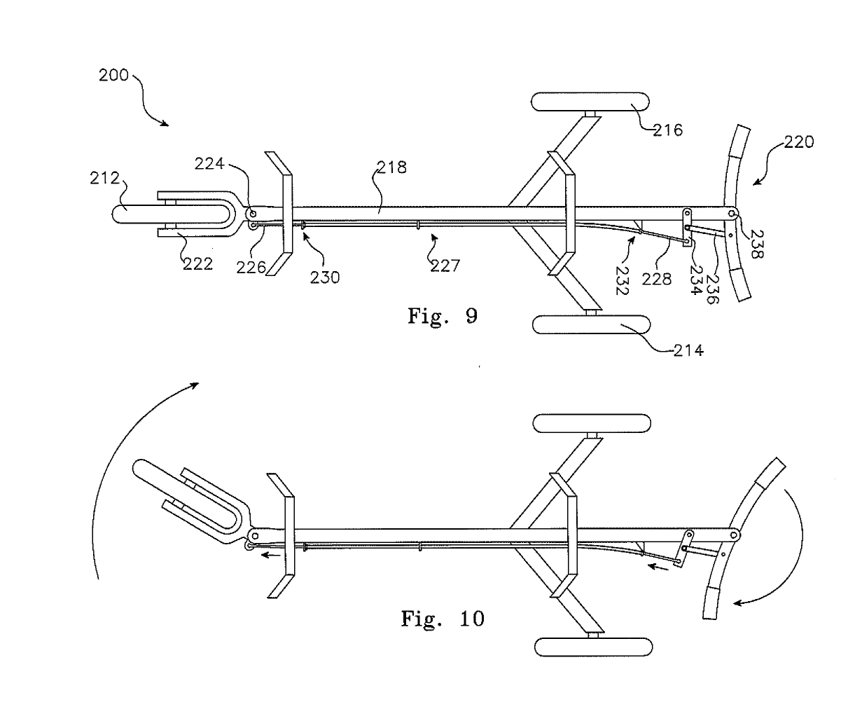

In a further preferred embodiment of the invention with reference now to FIGS. 9 and 10, a three wheeled golf buggy 200, is again provided with an articulated front wheel 212, and rear wheels 214 and 216. Front wheel 212 is likewise supported in a fork 222 pivotable about centre 224. The golf buggy of this embodiment also is provided with a steering handle 220 pivotally mounted to the main frame 218.

In this embodiment however, movement of the articulated front wheel 212 and the fork 222 is induced by a single cable only; in this case a Morse type Bowden cable 227. Morse type Bowden cables are distinguished from the more common standard Bowden cable by having rigid rod elements 226 and 228 projecting from the respective leading end 230 and trailing end 232 which are affixed to the frame member 218. Rigid rod elements 226 and 228 are interconnected by a flexible cable running through the cable's outer sheath, as in a standard Bowden cable.

These rigid rod elements allow a Morse type Bowden Cable to be double acting in the sense that force may be provided to objects connected to the rod end at the remote or leading end of the cable in extension as well as in retraction.

As can be seen in FIGS. 9 and 10, in this embodiment, a single Morse type Bowden Cable 227 acts between the steering handle 220 and the front fork 222. Preferably, the trailing end rigid rod element 228 is pivotally connected to the steering handle 220 via auxiliary levers 234 and 236. Rotation of the steering handle 220 about its pivot point 238 in a clockwise direction (as seen from above) drives rigid rod 228 further into the outer sheath end 232 of the cable 227. The flexible section of the inner cable, confined in the outer sheath, then forces rigid rod 226 to extend further from the sheath at the leading end 230 and causes the fork 222 and front wheel 212 to likewise rotate in a clockwise direction.

It will be understood that, rotation of the steering handle 220 in a counter clockwise direction, will draw the ridged rod elements of the cable in the opposite direction, acting in effect in the manner of a standard Bowden Cable, and turning the front wheel in a counter clockwise direction.

As in the previously described embodiments above, a centering spring may be provided at either the steering handle or the articulated front wheel, or at both, to bias the steering arrangement of the golf buggy into the straight forward direction.

### INDUSTRIAL APPLICABILITY

The steering arrangement of the invention provides a relatively simple system for conveniently steering a buggy by a convenient rotation of the handle.

1. A steering system for a three-wheeled buggy; the buggy including a pair of spaced apart rear wheels and a front wheel attached to a frame; the buggy further including a steering handle pivotally mounted to the frame; the handle operatively interconnected with an articulated frame member supporting the front wheel.

2. The system of claim 1 wherein the articulated frame member is a fork; the fork pivoting about a generally vertical axis relative a main portion of the frame.

3. The system of claim 1 or 2 wherein rotation of the steering handle relative the frame results in rotation of the fork about the generally vertical axis.

4. The system of claim 3 wherein rotation of the steering handle is communicate to the fork and the front wheel through at least one flexible cable.

5. The system of claim 3 wherein rotation of the steering handle is communicated to the fork through a pair of flexible cables; a tensioning of the first flexible cable of the pair of flexible cables causing a rotation of the fork to the right relative the main portion of the frame; a tensioning of the second flexible cable of the pair of flexible cables causing a rotation of the fork to the left when the steering handle is rotated respectively in a clockwise and an anti-clockwise direction about a pivot axis of the steering handle.

6. The system of claim 4 or 5 wherein the at least one or the pair of flexible cables are Bowden cables; the cables comprising a flexible outer sheath and a flexible inner cable.

7. The system of any one of claim 6 or 7 wherein a first end of the inner cable of the at least one, or the pair of flexible cables, is attached to a body rigidly mounted to a pivot shaft of the steering handle; a first end of a corresponding flexible outer sheath affixed to the main portion of the frame proximate the body.

8. The system of claim 6 or 7 wherein a second end of the inner cable of the at least one, or the pair of flexible cables, is attached to the fork; a second end of a corresponding outer sheath affixed to the main portion of the frame proximate the generally vertical axis.

9. The system of any one of claims 6 to 8 wherein a connection point of the first end of the inner cable on the body lies at a radial distance from the pivot axis such that a maximum angle of rotation of the body with rotation of the steering handle causes a tensioning of the inner cable sufficient to urge a maximum rotation of the front wheel.

10. The system of any one of claims 6 to 9 wherein the body comprises at least a portion of a cylinder; the first end of at least one or each inner cable attached at a periphery of the grooved cylinder; a portion of the inner cable passing around a portion of the periphery.

11. The system of claim 4 wherein the at least one flexible cable is a single Morse type Bowden cable; rigid rod elements at leading and trailing ends of the single Morse type Bowden cable linked respectively to the fork of the front wheel and to the steering handle; the rigid rod elements interconnected by a flexible cable extending through an outer sheath of the Morse type Bowden cable.

12. The system of any previous claim wherein a spring acts between the front wheel and the frame to bias the front wheel into a default centered position.

13. A method of steering a three-wheeled golf buggy; the method including the steps of:
rotating a steering handle portion of a frame of the buggy relative the frame,
transmitting rotation of the steering handle portion to an articulated front wheel of the buggy via at least one or a pair of cables.

14. The method of claim 13 wherein the at least one or pair of cables are flexible Bowden cables.

15. The method of claim 13 wherein the at least one or a pair of cables comprises a single Morse type Bowden cable.

16. The method of claim 13 or 14 wherein rotation of the steering handle is transmitted to the articulated front wheel by a pair of flexible Bowden cables.

17. The method of claim 16 wherein rotation of the steering handle portion rotates a grooved cylindrical body;
first ends of inner cables of the pair of flexible Bowden cables attached to, and at least partly wound around, respective grooves of the grooved cylindrical body.

18. The method of claim 16 or 17 wherein second ends of the inner cables of the pair of flexible Bowden cables are attached to respective sides of a front fork of the articulated front wheel.

19. The method of claims 13 and 15 wherein rotation of the front wheel about an axis of rotation is driven by extension and retraction of a leading end rigid rod extending from a leading end of the single Morse type Bowden cable and connected to the front fork of the golf buggy; extension and retraction of the leading end rigid rod being induced by rotation of the steering handle connected to a trailing end rigid rod extending from a trailing end of the single Morse type Bowden cable.
